(19) United States
(12) Patent Application Publication
(10) Pub. No.: US 2008/0102168 A1
(43) Pub. Date: May 1, 2008

(54) HIGH-PROTEIN SOY-WHEAT CRISPS

(76) Inventors: Cheryl K. Borders, Moweaqua, IL (US); Michael J. Fleckenstein, Decatur, IL (US)

Correspondence Address: ARCHER DANIELS MIDLAND COMPANY, 4666 FARIES PARKWAY, DECATUR, IL, 62526, US

(21) Appl. No.: 11/931,430

(22) Filed: Oct. 31, 2007

Related U.S. Application Data
(63) Continuation-in-part of application No. 11/540,080, filed on Sep. 29, 2006.

(51) Int. Cl. A23K 1/00; A23L 1/00; A23L 1/03; A23L 1/035; A23L 1/053; A23L 1/0562; A23L 1/10; A23L 1/29; A23L 1/30; A23L 1/302

(52) U.S. Cl. 426/72; 426/548; 426/611; 426/622; 426/623; 426/93

(57) ABSTRACT

Sterol containing food products are disclosed. The food products contain a sterol and at least one of a corn product, a legume product and a flour product, and can be made by extrusion.

### CROSS-REFERENCE TO RELATED APPLICATION

This application claims priority as a continuation-in-part of pending U.S. patent application Ser. No. 11/540,080 filed on Sep. 29, 2006, which itself claims priority of U.S. Provisional Application No. 60/722,266, filed on Sep. 30, 2005, and U.S. Provisional Application No. 60/786,151, filed on Mar. 24, 2006, each of the contents of the entirety of which are incorporated by this reference.

### FIELD OF THE INVENTION

The invention pertains to high protein food products.

### BACKGROUND

Many food products, particularly snack foods, are carbohydrate-based. However, the prevalence of carbohydrate-based foods has been linked to a rise in the incidence of obesity, diabetes, and other diseases.

Because many snack foods are processed, changing the formulation of a food product can be challenging. The product must still be palatable and digestible, and the product must be capable of successfully being processed on existing manufacturing equipment. Furthermore, the new food product will need to have a taste, texture and mouth feel similar to existing carbohydrate-based food products.

### SUMMARY OF THE INVENTION

High-protein crisps are disclosed, and methods of making such high-protein crisps.

In one embodiment, a process for producing a high-protein food product includes: combining soy protein and at least one additional protein to produce a first mixture, adding water to the first mixture and combining to produce a second mixture, and extruding the second mixture, thus producing a high-protein food product. The extruding can include subjecting the second mixture to heat and pressure. The process may also include drying the high-protein food product.

In one embodiment, the soy protein can be at least about 70% of the dry weight of the first mixture. The soy protein can be about 70% to about 74% of the weight of the dry mixture, the additional protein can be wheat gluten and be about 23% to about 27% of the weight of the dry mixture, and the dry mixture can include calcium carbonate as about 0.10% to about 6% of the dry weight of the dry mixture.

Also disclosed are high-protein food products made by the processes described herein.

Also disclosed are foodstuffs into which the high-protein food products have been incorporated.

Also disclosed is a high-protein food product consisting essentially of soy protein and at least one additional protein.

Another embodiment discloses an extruded product that includes a protein source and a nutraceutical.

In one embodiment, the high-protein food products and extruded products can have a protein content of at least about 70% on an as-is basis. In other embodiments, the high-protein food products and/or the extruded products may have a protein content of at least 80% or even at least 85% protein. The products can have a carbohydrate content of at less than about 5% on an as-is basis, e.g., from about 1% to about 3% on an as-is basis.

The high-protein food product and extruded product can be a chip, crisp, cracker, cereal piece, cookie piece, or a snack food. The high-protein food product can be an extruded dough, protein flakes, or protein nuggets.

Another embodiment discloses a method of increasing the protein content of a foodstuff, by incorporating the high-protein food product or the extruded product into the foodstuff.

Also disclosed is a method of increasing protein consumption in a population, by distributing the high-protein food products to the population.

In further embodiments, the extruded product may also include a nutraceutical which can be a sterol, lignan, glucosamine, an isoflavone, or any combinations of any thereof. The protein can be soy protein. The additional protein can be milk protein, caseinate, whey protein, buttermilk solids, milk powders, egg protein, canola protein, pea protein, wheat protein, wheat gluten, potato protein, corn protein, sesame protein, sunflower protein, cottonseed protein, copra protein, palm kernel protein, safflower protein, linseed protein, peanut protein, lupin protein, edible bean, oat protein, and other legume, cereal proteins, or mixtures of any thereof. The processes and products can also include the addition of calcium carbonate.

Seasonings can also be included in the food products.

It should be understood that this invention is not limited to the embodiments disclosed in this summary, or the description that follows, but is intended to cover modifications that are within the spirit and scope of the invention, as defined by the claims.

### DETAILED DESCRIPTION

Other than in the examples described herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein in its entirety is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present invention includes high-protein extruded products, and methods of making such extruded products. The extruded products are useful in that they present a high-protein product in a form normally associated by consumers with a high-carbohydrate product. As used herein, the term “high-protein” will be used to mean that the high-protein product has a protein content of at least about 70% on an “as-is” basis, that is at a level as the high-protein product is consumed by a customer or incorporated into a food product.

The food product may be made from soy protein and at least one additional protein. In one embodiment, the food product may be made from soy protein, wheat gluten, and calcium carbonate. In one embodiment, the food product may be extruded.

In one embodiment, the high-protein extruded product has a carbohydrate content of less than about 5% on an “as-is” basis, and in another embodiment the high-protein extruded product has a carbohydrate content of about 1-3% on an “as-is” basis. In these embodiments, the carbohydrate may comprise, without limitation, a starch or a fiber.

In one embodiment, the ingredients are fed into an extruder, where the ingredients are mixed, optionally wetted, and heated under pressure. The mixed ingredients may be extruded through a die and cut, optionally with a knife. The exact die and cutting regimen may vary depending on the product being made.

Any type of soy protein can be used in the invention. Commercially available soy proteins include, but are not limited to, PROFAM 974, PROFAM 880, PROFAM 825, PROFAM 873, PROFAM 781, PROFAM 780 (Archer Daniels Midland Company, Decatur, Ill., USA) and the like, and combinations thereof.

Any type of protein can be included as the additional protein, including, but not limited to, milk protein, milk protein isolate, milk powders, buttermilk solids, whey protein, whey protein concentrate, whey protein isolate, caseinate, rennet casein, acid casein, egg protein, wheat protein, wheat protein isolate, modified wheat protein isolate such as PROLITE 100 or PROLITE 200 (Archer Daniels Midland Company, Decatur, Ill., USA), gluten, rice protein, soy protein, zein, corn protein, canola protein, pea protein, potato protein, sesame protein, sunflower protein, cottonseed protein, copra protein, palm kernel protein, safflower protein, linseed protein, peanut protein, lupin protein, edible bean, oat protein, other legume or cereal proteins, hydrolyzed proteins, amino acids, peptides, and the like, and combinations thereof. In one embodiment, the additional protein is wheat gluten. PROLITE LF (Archer Daniels Midland Company, Decatur, Ill., USA) is an example of commercially available wheat gluten that may be employed in the present invention. Other sources of wheat gluten can also be used.

Additional ingredients may be added such as, for example, spices and seasonings, oils, and various processing aids, such as chemical additives which affect functionality and shelf life. Combinations of such ingredients may also be used.

“Seasonings” can include, but are not limited to, minerals such as salt, grain-based seasonings (such as, but not limited to, whole, cracked or ground wheat, corn, oats, rye, flax, barley, spelt and rice), plant-derived seasonings (such as, but not limited to, onion, garlic, pepper, capsicum pepper, herbs, spices, nuts, olives, fruits, vegetables, etc.), and other flavorings (such as, but not limited to, vanilla, sugar, cheese, yeast extract, whey), and combinations thereof.

Vitamins can also be included in the food product such as, but not limited to, niacin, iron, zinc, thiamine mononitrate (vitamin B1), riboflavin (vitamin B2), folic acid, tocopherol(s) (vitamin E), vitamin C, vitamin B6, vitamin B12, vitamin A, vitamin D, pantothenic acid and copper.

Edible oil and fat can also be included in the food product. Oils such as, but not limited to, soy, corn, canola, sesame, safflower, olive, sunflower, rapeseed, cottonseed, peanut, copra, palm kernel, palm, linseed, lupin, and combinations thereof can be used. Other fats such as butter or lecithin and their mixtures can also be used.

Other ingredients can be included such as emulsifiers (such as, but not limited to, lecithin, soy lecithin), leavening (such as, but not limited to, baking soda, calcium phosphate, yeast), natural and artificial sweeteners, preservatives (such as, but not limited to, BHT, BHA, and tocopherol), fiber (such as, but not limited to, insoluble fiber, soluble fiber (e.g., Fibersol®)), and any combinations of such ingredients.

In one embodiment, the crisps of the present invention may be made with an extruder. In these types of machines, the dry ingredients may be mixed with water, and the resulting material may be extruded under high temperature and pressure. The material may be extruded out of the machine. When the pressurized material is exposed to atmospheric pressure and ambient temperature, it expands and cools, resulting in a puffed product. The puffed product can be of different shapes and sizes, depending on the die through which it passes and the frequency with which it is cut.

There are many different types of extruders, and they are able to perform all of the required steps set forth above, so that little or no pre- or post-processing is required. Various parts that may be associated with the extruder can grind the ingredients, hydrate them, shear, homogenize, mix, compress, and degas the ingredients.

The extruding can include, for example, melting and/or plasticization of the ingredients, gelatinization of starch and denaturation of proteins. The heat can be applied either through, for example, steam injection, external heating of the barrel, or mechanical energy. The material can be pumped, shaped and expanded, which forms the porous and fibrous texture, and partially dehydrates the product. The shape and size of the final product can be varied by using different die configurations. Extruders can be used to make products with little expansion (such as pasta), moderate expansion (shaped breakfast cereal, soy meat substitutes, breading substitutes, modified starches, pet foods (soft, moist and dry)), or a great deal of expansion (puffed snacks, puffed curls and balls, etc.).

In some extruders, the material may be extruded by means of a ram or a piston. Other extruders use one or more screws. Variable pitch single screw extruders produce high product consistency by combining the ingredients to produce a homogeneous mixture, and pushing it out of the machine at a rate that is highly controllable.

Twin screw extruders contain two screws that are either co-current (the screws rotate in the same direction) or are counter-current (the screws rotate in opposite directions). Twin screw extruders can handle material with a wide range of moisture content, and have greater control over the residence time and the amount of shear to which the material is exposed.

The ingredients may be fed into the extruder via a feeder, such as, but not limited to, a gravimetric or volumetric feeder. The type of feeder used depends on the type of ingredient, and different feeders are used for batch versus continuous feed. The feeder also can direct the ingredients into a preconditioner, if desired.

The feed section of the screw may have deep flights to accept the ingredients and move the ingredients forward. The ingredients move into the compression section of the screw, which is heated, and has either more shallow or more frequent flights, which compresses the ingredients and works them into continuous dough. The cooking section of the screw applies maximum heat, pressure and shear to the mixture in the barrel prior to the die. Within the screw barrel, the mixture is heated and pressurized. When the mixture emerges through the die, the reduction in pressure to atmospheric pressure generally causes the mixture to expand. If the moist dough within the barrel is heated over 100° C., the sudden reduction in pressure to atmospheric pressure causes the moisture to convert to steam. The combination of sudden expansion and associated cooling yields a puffed, crisp product.

After extrusion, the product may be dried. The final product will have a moisture content of from about 1% to about 8%, depending on the desired characteristics of the finished product.

After production, the crisps are packaged for storage and/or sale. Any of the processes described herein may further include at least one of the following acts: placing the crisps in a container which may be configured for shipping; associating indicia with the container, such as, for example, placing graphical, written, or numerical indicia on the container, wherein the indicia may be capable of describing the contents of the container, designating the producer of the contents, and/or directing an end user, such as, for example, a consumer, on how to use the product; shipping the container containing the product, wherein any conventional method of shipping may be used, such as, for example, shipping by truck, train, ship, or plane; and combinations of any thereof.

The food product produced using the methods described herein can be in the form of crunchy curls, puffs, chips, crisps, crackers, wafers, flat breads, biscuits, crisp breads, protein inclusions, cones, cookies, flaked products, fortune cookies, etc. The food product can also be in the form of pasta, such as dry pasta or a ready-to-eat pasta. The product can be used as or in a snack food, cereal, or can be used as an ingredient in other foods such as a nutritional bar, breakfast bar, breakfast cereal, or candy.

In various embodiments, the processing conditions and the amounts and types of ingredients can be modified so as to change the nutritional levels of the finished product, as well as for altering the handling, stability, shelf life, texture, flavor, functional properties and ease of manufacture of the product.

As an indication of how various conditions and amounts of ingredients may vary and as shown in the following examples, a formulation of soy protein (PROFAM 873; 82.75% w/w), wheat gluten (PROLITE LF; 15.00% w/w) and calcium carbonate (2.25% w/w) produced a product that was over expanded and had poor shape (Batch #1.1 in Example 1, below). However, the product did not collapse after expanding, as did a product made with equal parts of soy protein and wheat gluten (Batch #1.2, Example 1). It also did not burn as Batch #1.3 did, which contained equal parts soy protein, wheat protein isolate and wheat gluten.

Formulations that included rice starch (Example 2) or tapioca starch (Example 3) was also tested. The formulations of Example 2 and Example 3 produced over- and under expanded pieces at the cited levels. Lower starch levels can be used to control the consistency of the food product.

In Example 3, it was found that the control formulation containing no starch (Batch #3.1) generated a good product. This discovery led back to the formulations of Example 1, of which Batch #1.1 (82.75% soy protein, 15.00% wheat gluten, 2.25% calcium carbonate) had performed well. Tests were also performed (Example 4) to determine the formulations that work well, and it was found that a mixture of about 72% soy protein, about 25% wheat gluten, and 3% calcium carbonate performed well.

The present invention may be further understood by reference to the following examples. The following examples are merely illustrative of the invention and are not intended to be limiting. Unless otherwise indicated, all parts are by weight.

### EXAMPLES

### Example 1

### Formulations for Soy-Wheat High-Protein Crisps

This example provides three formulations for producing a high-protein crisp.

In each of the formulations listed herein, the ingredients were blended for 10 minutes at ambient temperature in a ribbon blender (JH Day). The blend was transferred to a live bottom bin feeding a Wenger TX 52 twin screw extruder. The extruder screw profile was made up of a combination of feed screws, and forward and reverse shearlocks. The end die plate contained several 1×3 mm slots. The blended material was fed into the feed throat of the extruder at a rate of 75 lbs per hour, and water was added to approximately 18%. The extrusion temperatures were set to (from inlet to die) 140° F.→200° F.→200° F.→200° F.→200° F.→265° F.→265° F. The screw speed was 350 rpm and the die pressure was 700 psi. The extrudate was cut into small crisps with a rotating knife. These small crisps were dried in a drier (Wolverine Proctor Swartz, Merrimac, Mass., USA) for 20 minutes at 250° F.

TABLE 1
Formulation and manufacturing conditions for Batches #1.1, #1.2 and #1.3.

| | Batch #1.1 | | Batch #1.2 | | Batch #1.3 | |
|---|---|---|---|---|---|---|
| Ingredients | Percentage | Weight | Percentage | Weight | Percentage | Weight |
| PROFAM 873 | 82.75 | 44.00 | 48.90 | 29.34 | 32.60 | 19.56 |
| PROLITE LF | 15.00 | 8.00 | 48.85 | 29.31 | 32.60 | 19.56 |
| PROLITE 100 | — | — | — | — | 32.55 | 19.53 |
| Calcium | 2.25 | 1.20 | 2.25 | 1.35 | 2.25 | 1.35 |
| carbonate | | | | | | |

| | | |
|---|---|---|
| Extruder rpm | 300 | 300 |
| Cylinder | 225 | 225 |
| Feeder | 10 | 10 |
| Load | 21 | 24 |
| Knife | 1811 | 1811 |
| 1 | 87 | 87 |
| 2 | 105 | 101 |
| 3 | 145 | 140 |
| 4 | 202 | 205 |
| 5 | 290 | 312 |
| 6 | 309 | 331 |
| Water | 190 | 190 |
| Psi | 875 | 1100 |
| Density | 122 | |

All weights are provided in pounds.

Batch #1.1 was slightly over expanded, and the product had a poor shape. The product from Batch #1.2 was also over expanded. The level of wheat in Batch #1.3 was too high, and the product burned.

### Example 2

### Formulations for High-Protein Crisp with Rice Starch

This example discloses additional formulations for a high-protein crisp. The extruder was the same as in Example 1, above. The formulations include soy and wheat protein, rice starch, and calcium carbonate (Batches 2.1, 2.2).

TABLE 2
Formulation and manufacturing conditions
for Batches #2.1 and #2.2.

| | Batch #2.1 | | Batch #2.2 | |
|---|---|---|---|---|
| Ingredients | Percentage | Weight | Percentage | Weight |
| PROFAM 880 | 74.35 | 48.3 | 74.35 | 48.3 |
| PROLITE LF | 20.00 | 13.0 | — | — |
| PROLITE 100 | — | — | 20.00 | 13.0 |
| Rice Starch | 5.40 | 3.50 | 5.40 | 3.50 |
| Calcium carbonate | 0.25 | 74 gm | 0.25 | 74 gm |
| Extruder rpm | 375 | 375 | | |
| Cylinder | 121 | 121 | | |

| | | |
|---|---|---|
| Feeder | 11 | 11 |
| Load | 33 | 33 |
| Knife | 2008 | 2008 |
| Zone 1 | 145 | 145 |
| Zone 2 | 155 | 155 |
| Zone 3 | 122 | 122 |
| Zone 4 | 207 | 207 |
| Zone 5 | 258 | 258 |
| Zone 6 | 261 | 261 |
| Water | 300 | 300 |
| Psi | 490 | 490 |
| Density | 250 | 250 |

All weights are provided in pounds, except where otherwise indicated.

Batch #2.1 had a suboptimal screw profile and starch level. Variation in rpm and water produced over- and under expanded products. Batch #2.2 produced similarly underperforming products, and the extruder also could not maintain pressure.

### Example 3

### Test Formulations for High-Protein Crisp with Tapioca Starch

This example provides three formulations for a high-protein crisp made from soy and wheat protein, and either calcium carbonate (Batch #3.1), tapioca starch (Batch #3.2), or both (Batch #3.3).

TABLE 3
Formulation and manufacturing conditions for Batches #3.1, #3.2 and #3.3.

| | Batch #3.1 | | Batch #3.2 | | Batch #3.3 | |
|---|---|---|---|---|---|---|
| Ingredients | Percentage | Weight | Percentage | Weight | Percentage | Weight |
| PROFAM 825 | 77.0 | 38.5 | 75.0 | 37.5 | 73.5 | 36.75 |
| PROLITE LF | 20.0 | 10.0 | 20.0 | 10.0 | 20.0 | 10.00 |
| Tapioca Starch | — | — | 5.0 | 2.5 | 5.0 | 2.50 |
| Calcium | 3.0 | 1.5 | — | — | 1.5 | 0.75 |
| carbonate | | | | | | |

| | | | |
|---|---|---|---|
| Extruder rpm | 370 | 370 | 370 |
| Cylinder | 120 | 120 | 120 |
| Feeder | 10 | 10 | 10 |
| Load | 26 | 26 | 26 |
| Knife | 1877 | 1877 | 1877 |
| Zone 1 | 147 | 147 | 147 |
| Zone 2 | 198 | 198 | 198 |
| Zone 3 | 202 | 202 | 202 |
| Zone 4 | 206 | 206 | 206 |
| Zone 5 | 248 | 248 | 248 |
| Zone 6 | 252 | 252 | 252 |
| Water | 206 | 206 | 206 |
| psi | 600 | 600 | 600 |
| Density | 210 | 210 | 210 |

All weights are provided in pounds, except where otherwise indicated.

In Batch #3.1, the density and the appearance of the product could be changed by changing the run conditions, and the low-density product looked better. Batch #3.2 produced over- and under expanded product due to the starch level. The product from Batch #3.3 was similar, looked very poor, had many large and small translucent cells, and small nonexpanded pieces.

### Example 4

### Soy-Wheat High-Protein Crisps

This example provides three formulations of crisps made from soy protein, wheat protein, and calcium carbonate.

TABLE 4
Formulation and manufacturing conditions for Batches #4.1, #4.2 and #4.3.

| | Batch #4.1 | | Batch #4.2 | | Batch #4.3 | |
|---|---|---|---|---|---|---|
| Ingredients | Percentage | Weight | Percentage | Weight | Percentage | Weight |
| PROFAM 974 | 72.0 | 36.0 | — | — | — | — |
| PROFAM 873 | — | — | 77.0 | 38.5 | 72.0 | 36.0 |
| PROLITE LF | 25.0 | 12.5 | 20.0 | 10.0 | 25.0 | 12.5 |
| Calcium carbonate | 3.0 | 1.5 | 3.0 | 1.5 | 3.0 | 1.5 |

| | | | |
|---|---|---|---|
| Extruder rpm | 350 | 350 | 350 |
| Cylinder | 120 | 120 | 120 |
| Feeder | 10 | 10 | 10 |
| Load | 34 | 33 | 29 |
| Knife | 1960 | 2222 | 2280 |
| Zone 1 | 142 | 144 | 146 |
| Zone 2 | 200 | 201 | 181 |
| Zone 3 | 203 | 204 | 201 |
| Zone 4 | 24 | 204 | 206 |
| Zone 5 | 267 | 270 | 264 |
| Zone 6 | 263 | 263 | 259 |
| Water | 294 | 279 | 253 |
| psi | 670 | 720 | 770 |
| Density | 198 | 148 | 186 |
| Moisture | 1.46 | 1.14 | 1.32 |

All weights are provided in pounds, except where otherwise indicated.

The product formed in Batch #4.1 was similar to crisped rice, having a very light and crunchy texture with a good nutritional profile. This was also true of Batch #4.2, in which the product varied in appearance. Batch #4.3 produced pieces with good texture and color, but the size of the pieces were inconsistent.

Component analyses for samples from Batch #4.1 are disclosed in Tables 5-7, below. Table 5 shows a general nutritional analysis, Table 6 shows the amino acid profile, and Table 7 shows the fat profile and fatty acid analysis.

TABLE 5
Nutritional Analysis of Product from Batch #4.1.

| Assay | Component | Results | Units |
|---|---|---|---|
| Calories, no fiber correction | Calories | 366 | Calories/100 g |
| Calories from fat | Calories | 25 | Calories/100 g |
| Calories from saturated fat | Calories | 6 | Calories/100 g |
| Fatty acid analysis w/profile | Total Fat | 2.80 | % |
| | Saturated Fat | 0.66 | % |
| | Monounsaturated fat | 0.40 | % |
| | cis-cis polyunsaturated fat | 1.59 | % |
| | trans fat | 0.03 | % |
| Sodium | Sodium | 1300 | mg/100 g |
| Potassium | Potassium | 424 | mg/100 g |
| Carbohydrates, Total | Carbohydrates | 1.4 | % |
| Fiber, Total Dietary | Total Dietary Fiber | 1.3 | % |
| Sugars by HPLC | Total Sugar | 0.280 | % |
| | Fructose | 0.00 | % |
| | Glucose | 0.00 | % |
| | Sucrose | 0.28 | % |
| | Maltose | 0.00 | % |
| | Lactose | 0.00 | % |
| Protein by Dumas (F-6.25) | Protein | 83.8 | % |
| Calcium | Calcium | 77.9 | mg/100 g |
| Iron | Iron | 8.80 | mg/100 g |
| Moisture/Vacuum Oven (70 C./16 hr) | Moisture | 5.72 | % |
| Ash, Overnight (16 hr) | Ash | 6.28 | % |

TABLE 6
Amino Acid Profile of Product from Batch #4.1.

| Assay | | |
|---|---|---|
| Total Amino Acid Profile | Analysis | Units |
| Aspartic Acid | 7760 | mg/100 gm |
| Threonine | 2660 | mg/100 gm |
| Serine | 4350 | mg/100 gm |
| Glutamic Acid | 18800 | mg/100 gm |
| Proline | 5910 | mg/100 gm |
| Glycine | 3160 | mg/100 gm |
| Alanine | 3090 | mg/100 gm |
| Cysteine | 1150 | mg/100 gm |
| Valine | 3660 | mg/100 gm |
| Methionine | 1150 | mg/100 gm |
| Isoleucine | 3560 | mg/100 gm |
| Leucine | 6290 | mg/100 gm |
| Tyrosine | 3020 | mg/100 gm |
| Phenylalanine | 4420 | mg/100 gm |
| Histidine | 2100 | mg/100 gm |
| Lysine | 3820 | mg/100 gm |
| Arginine | 5520 | mg/100 gm |
| Tryptophan | 1120 | mg/100 gm |

Table 7 shows the fat profile and fatty acid analysis of the product from Batch #4.1. The column labeled “Nor” indicates the fatty acids normalized by weight, and expressed as a percentage. The column labeled “% Tri” indicates the fatty acids as percent (w/w) of triglyceride in the product. The remaining columns show the saturated fatty acids (“Sat FA”), monounsaturated fatty acids (“Mono FA”), cis-cis polyunsaturated fatty acids (“Poly FA”) and trans fatty acids (“trans FA”) as percent (w/w) of the fatty acids in the product.

TABLE 7
Fat Profile/Fatty Acid Analysis (With cis-cis
Polyunsaturates) of Batch #4.1 Product.

| | | | | % (w/w) FA in Product | | | |
|---|---|---|---|---|---|---|---|
| | | | | Sat | Mono | Poly | trans |
| | Fatty Acid | Nor | % Tri | FA | FA | FA | FA |
| 4:0 | Butyric | | | | | | |
| 6:0 | Caproic | | | | | | |
| 8:0 | Caprylic | 0.214 | 0.006 | 0.006 | | | |
| 10:0 | Capric | 0.178 | 0.005 | 0.005 | | | |
| 12:0 | Laurie | | | | | | |
| 13:0 | Tridecanoic | | | | | | |
| 14:0 | Myristic | 0.071 | 0.002 | 0.002 | | | |
| 14:1 | t-Tetradecenoic | 0.071 | 0.002 | | | | 0.002 |
| 14:1 | Myristoleic | | | | | | |
| 15:0 | Pentadecanoic | 0.107 | 0.003 | 0.003 | | | |
| 15:1 | Pentadecenoic | | | | | | |
| 16:0 | Palmitic | 19.544 | 0.548 | 0.522 | | | |
| 16:1 | t-Hexadecenoic | 0.107 | 0.003 | | | | 0.003 |
| 16:1 | Palmitoleic | 0.107 | 0.003 | | 0.003 | | |
| 17:0 | Margaric | 0.143 | 0.004 | 0.004 | | | |
| 17:1 | Margaroleic | 0.071 | 0.002 | | 0.002 | | |
| 18:0 | Stearic | 3.317 | 0.093 | 0.089 | | | |
| 18:1 | trans Elaidic | 0.143 | 0.004 | | | | 0.004 |
| 18:1 | Oleic | 14.444 | 0.405 | | 0.388 | | |
| 18:2 | trans- | 0.678 | 0.019 | | | | 0.018 |
| | Octadecadenoic | | | | | | |
| 18:2 | Linoleic | 54.030 | 1.515 | | | 1.449 | |
| 20:0 | Arachidic | 0.176 | 0.005 | 0.005 | | | |
| 18:3 | gamma-Linolenic | 0.107 | 0.003 | | | 0.003 | |
| 20:1 | Gadoleic | 0.357 | 0.010 | | 0.010 | | |
| 18:3 | Linolenic | 5.064 | 0.142 | | | 0.136 | |
| 21:0 | Heneicosanoic | | | | | | |
| 18:2 | conj-Linoleic | 0.071 | 0.002 | | | | |
| 18:4 | Octadecatetraenoic | | | | | | |
| 20:2 | Eicosadienoic | 0.071 | 0.002 | | | 0.002 | |
| 22:0 | Behenic | 0.357 | 0.010 | 0.010 | | | |
| 20:3 | gamma- | | | | | | |
| | Eicosatrienoic | | | | | | |
| 22:1 | Erucic | 0.036 | 0.001 | | 0.001 | | |
| 20:3 | Eicosatrienoic | | | | | | |
| 20:4 | Arachidonic | | | | | | |
| 23:0 | Tricosanoic | 0.107 | 0.003 | 0.003 | | | |
| 22:2 | Docosadienoic | | | | | | |
| 24:0 | Lignoceric | 0.285 | 0.008 | 0.008 | | | |
| 20:5 | Eicosapentaenoic | | | | | | |
| 24:1 | Nervonic | 0.036 | 0.001 | | 0.001 | | |
| 22:3 | Docosatrienoic | 0.107 | 0.003 | | | 0.003 | |
| 22:4 | Docosatetraenoic | | | | | | |
| 22:5 | Docosapentaenoic | | | | | | |
| 22:6 | Docosahexaenoic | | | | | | |
| | Totals | 100.0% | 1.80% | 0.66 | 0.40 | 1.59 | 0.03 |

### Example 5

### Soy-Wheat High-Protein Crisps

This example discloses formulations for soy-wheat high-protein crisps with improved flavor. In particular, ethyl vanillin and sucralose are added to mask any perceived bitter flavor from the protein isolate. The formulations are presented in Tables 8a and 8b.

TABLE 8a
Formulation for high-protein crisps.

| Ingredient | Percent by weight |
|---|---|
| PROFAM 781 | 71.96 |
| PROLITE LF | 24.99 |
| Calcium carbonate | 3.00 |
| Sucralose | 0.03 |
| Ethyl vanillin | 0.02 |

TABLE 8b
Formulation for high-protein crisps.

| Ingredient | Percent by weight |
|---|---|
| PROFAM 781 | 71.93 |
| PROLITE LF | 24.98 |
| Calcium carbonate | 3.00 |
| Sucralose | 0.07 |
| Ethyl vanillin | 0.03 |

Manufacturing conditions used in Example 5 were substantially similar to those as for Batch #4.1 in Example 4.

### Example 6

### Extruded Product Containing Nutraceuticals

An extruded food product was prepared as follows. Soy protein isolate (i.e., ADM Ardex F brand soy protein isolate, ADM ProFam 780 brand soy protein isolate, and combinations thereof) was mixed with tapioca starch, soy fiber, calcium carbonate and a nutraceutical (i.e., ADM brand Cardio Aid sterols), and the resulting mixture was blended. The resulting mixture was introduced into a live bottom bin that feeds a Wenger TX 52 twin screw extruder. The extruder conditions used to prepare the extruded food products were as follows:

TABLE 9
Conditions for extruded product containing nutraceuticals.

| | 1 | 2 | 3 | 4 | 5 | 6 |
|---|---|---|---|---|---|---|
| Extruder RPM | 330 | 335 | 328 | 332 | 330 | 340 |
| Cylinder RPM | 120 | 120 | 120 | 120 | 120 | 120 |
| Feeder RPM | | 10 | 10 | 10 | 10 | 10 |
| % Load | | 28 | 23 | 20 | 20 | 20 |
| Knife RPM | | 980 | 900 | 850 | 740 | 870 |
| Zone Temps inlet to outlet, in ° F. | | | | | | |
| Zone 1 | 146 | 134 | 132 | 132 | 133 | 131 |
| Zone 2 | 148 | 154 | 153 | 153 | 153 | 153 |
| Zone 3 | 169 | 170 | 170 | 170 | 176 | 202 |
| Zone 4 | 214 | 210 | 204 | 204 | 221 | 258 |
| Zone 5 | 260 | 232 | 228 | 228 | 260 | 284 |
| Zone 6 | 247 | 218 | 214 | 214 | 240 | 221 |
| Water Addition (ml/min) | 320 | 290 | 287 | 280 | 260 | 335 |
| Die Pressure (PSI) | 680 | 610 | 610 | 610 | 610 | 610 |
| Den | 266 | 234 | 237 | 238 | 151 | 150 |

The extruder screw profile was a combination of feed screws, and forward and reverse shearlocks. The resulting mixture was fed into the feed throat of the extruder, and water was added. The end die plate of the extruder was fitted with eight, 1×3 mm slots and six cutting blades. The extrudate or collet coming out of the extruder was cut and resulted in crisps suitable for use in or as snack foods.

Formulations used in the extrusion process were as follows in Table 10, below.

TABLE 10
Formulations for high-protein crisps.

| | Ingredient | Percentage | Amount | |
|---|---|---|---|---|
| Formulation 1 | Ardex F Disp | 59.25 | 22.00 | lbs |
| | Profam 780 | 31.00 | 11.51 | lbs |
| | Tapioca Starch | 8.50 | 3.15 | lbs |
| | Fibred (soy) | 1.00 | 169 | grams |
| | Cal Carbonate | 0.25 | 42 | grams |
| Formulation 2 | Ardex F Disp | 70.25 | 44.00 | lbs |
| | Profam 780 | 20.00 | 12.52 | lbs |
| | Tapioca Starch | 8.50 | 5.32 | lbs |
| | Fibred (soy) | 1.00 | 0.62 | lbs |
| | Cal Carbonate | 0.25 | 71 | grams |
| Formulation 3 | Ardex F Disp | 80.25 | 44.00 | lbs |
| | Profam 780 | 10.00 | 5.48 | lbs |
| | Tapioca Starch | 8.50 | 4.66 | lbs |
| | Fibred (soy) | 1.00 | 0.55 | lbs |
| | Cal Carbonate | 0.25 | 62 | grams |
| Formulation 4 | Ardex F Disp | 90.25 | 44.00 | lbs |
| | Tapioca Starch | 8.50 | 4.14 | lbs |
| | Fibred (soy) | 1.00 | 0.49 | lbs |
| Formulation 5 | Ardex F Disp | 87.99 | 44.00 | lbs |
| | Tapioca Starch | 8.29 | 4.14 | lbs |
| | Fibred (soy) | 0.97 | 0.49 | lbs |
| | Cal Carbonate | 0.25 | 0.12 | lbs |
| | Sterols-Cardio Aid | 2.50 | 1.25 | lbs |

### Example 7

### Extruded Cereal Products

In yet an additional embodiment, a nutraceutical containing crisp may be produced with the following formulation:

TABLE 11
Formulation for sterol-containing high-protein crisp.

| Ingredient | |
|---|---|
| White Corn Masa | 24.44 |
| Corn meal | 24.44 |
| Navy bean powder (dehydrated) | 29.33 |
| Whole wheat flour | 9.77 |
| Whole black beans (dehydrated) | 9.77 |
| Sterols (CardioAid M brand sterols, | 2.25 |
| available from ADM; Decatur, Illinois) | |

In this example, free sterols were added to the composition. The sterol composition, referred to in this example as CardioAid M brand sterols, is a white powder that originates from vegetable oils, is insoluble in water and has a melting point of 135-145° C. CardioAid M brand sterols are characterized by the following: a minimum of 95% total plant sterols, 40-58% beta-sitosterol, 20-30% campesterol, 14-22% Stigmasterol, 0-6% Braccicasterol, 0-5% sitistanol, 0-15 mg/g tocopherols, max 10 ppm heavy metals, max 1,000 standard plate count per gram, max 300 yeast and mold per gram, and negative for Salmonella, E. Coli and Staph. Aureus. In another embodiment, sterols can be added as characterized by the following: a minimum of 80% total plant sterols, 40-58% beta-sitosterol, 20-30% campesterol, 14-22% Stigmasterol, 0-6% Braccicasterol, 0-5% sitistanol, 0-15 mg/g tocopherols, max 10 ppm heavy metals, max 1,000 standard plate count per gram, max 300 yeast and mold per gram, and negative for Salmonella, E. Coli and Staph. Aureus.

The ingredients of the formulation were blended in a ribbon blender and fed into a Wenger 52 mm twin screw extruder containing a mixture of feeding and kneading elements, as well as forward and reverse shear locks. The die of the extruder had 4 heart shaped openings and the extrudate was cut with a rotating knife. It will be apparent by those of ordinary skill in the art that a die with any shaped opening may be used. The extruder conditions are in Table 12.

TABLE 12
Extrusion conditions for high-protein products.

| | |
|---|---|
| Extruder Screw RPM | 445 |
| PreConditioner RPM | 120 |
| Feeder RPM | 11 (about 60 lbs/hr) |
| % Motor Load | 32 |
| Rotating Knife RPM (two blades) | 1100 |
| Extrusion temperatures, inlet to outlet in ° F. | |
| Zone 1 | 165 |
| Zone 2 | 185 |
| Zone 3 | 200 |
| Zone 4 | 235 |
| Zone 5 | 280 |
| Zone 6 | 285 |
| Water Addition (milliliters/minute or about 16%) | 90 |
| Die Pressure (PSI) | 300 |

The extrudate was dried in a forced air drier for 20 minutes at 250° F. In another embodiment, the extrudate was placed in a fryer containing heated corn oil at 350° F. for 30 seconds. It will be appreciated by those of ordinary skill in the art that any type of edible or frying oil may be used including, but not limited to, sunflower oil, canola oil, soy oil, peanut oil, cotton seed oil, palm oil a diacylglycerol oil (i.e., ENOVA brand oil), or combinations of any thereof. The finished product had a pleasing flavor and a light crispy texture similar to a puffed snack or cereal. The product is high in fiber as compared to a conventional snack or cereal, and delivers at least 0.4 grams of sterols per serving. After drying or frying, the extrudate may be seasoned such as, for example, by coating the extrudate with a seasoning.

In another embodiment, the nutraceutical used in the extruded product may be, in addition to or in place of the sterols, a lignan (i.e., such as from flax), glucosamine, an isoflavone, or any combination thereof. In various embodiments, the nutraceutical may be present in concentrations of 0.1-10% or from 1-4%, depending on the desired concentration of the nutraceutical and serving size of the extruded product. For instance, when 2% sterols are added to extruded crisps, a serving size of 20 grams of crisps would be used to obtain 400 mg of sterols per serving of the crisps.

### Example 8

### High-Protein Soy Crisp

In another embodiment, the following formulation may be used to form a sterol containing product using the process for producing an extruded crisp as described in any of the preceding Examples.

TABLE 13
Formulation for sterol-containing high-protein crisp.

| Ingredient | Percentage |
|---|---|
| Ardex F Disp | 68.84 |
| ADM ProFam 780 | 19.60 |
| Tapioca Starch | 8.33 |
| Fibred (soy) (nucleating agent) | 0.98 |
| Cal Carbonate | 0.25 |
| Sterols | 2.00 |

### Example 9

### Snack or Nutrition Bar

In another embodiment, crisps produced from any of the Examples disclosed herein may be adhered together using a binder and, optionally, coated or enrobed with a coating, thus producing a snack bar, a nutrition bar or other handheld snack. The crisps, binder and/or the coating may further contain any of the following components in order to add functionality, texture or taste to the snack or nutrition bar: an enrichment; bulgar flour; rice flour; calcium citrate; plant sterols such as CARDIOAID brand sterols available from Archer Daniels Midland Company, Decatur, Ill.; a diacylglycerol oil such as ENOVA brand oil available from Archer Daniels Midland Company, Decatur, Ill.; a digestion resistant maltodextrin or soluble fiber such as FIBERSOL brand digestion resistant maltodextrin available from Archer Daniels Midland Company, Decatur, Ill.; a flour such as KANSAS DIAMOND brand whole wheat flour available from Archer Daniels Midland Company, Decatur, Ill.; zero or low trans-fat oil such as NOVA-LIPID brand oil available from Archer Daniels Midland Company, Decatur, Ill.; soy isoflavones such as NOVASOY brand isoflavones available from Archer Daniels Midland Company, Decatur, Ill.; a vitamin such as NOVATOL natural source vitamin E available from Archer Daniels Midland Company, Decatur, Ill.; an artificial sweeter such as, for example, sorbitol; a natural sweetener such as crystalline fructose; soy grits; dry sweeteners; soy flour; an emulsifier such as lecithin; and any combinations thereof.

The binder used to bind the crisps together may include, without limitation, a syrup such as corn syrup or rice syrup. In another embodiment, the binder may comprise the protein-based binder system which includes a protein and a sugar alcohol as described in U.S. patent application Ser. No. 11/473,662 filed on Jun. 23, 2006 entitled Binder for Particulate- and Powder-Type Food Systems and Related Methods assigned to Archer Daniels Midland Company of Decatur, Ill., the contents of the entirety of which is incorporated by this reference.

While this invention has been particularly shown and described with references to exemplary embodiments thereof, it will be understood by those skilled in the art that various changes in form and details may be made therein without departing from the scope of the invention encompassed by the appended claims.

What is claimed is:

1. An extruded product comprising:
an isolated or purified sterol; and
a compound selected from the group consisting of a corn product, a legume product, a rice product, a flour product and any combination thereof.

2. A food product comprising the extruded product of claim 1.

3. The extruded product of claim 1, wherein the isolated or purified sterol is present in a concentration of 0.1% to 10%.

4. The extruded product of claim 1, wherein the isolated or purified sterol is present in a concentration of 1.0% to 4.0%.

5. The extruded product of claim 1, wherein the isolated or purified sterol has at least 95% free sterols.

6. The extruded product of claim 1, wherein the isolated or purified sterol has at least 85% free sterols.

7. The extruded product of claim 1, wherein the extruded product is selected from the group consisting of a chip, a crisp, a cracker, a cereal piece, a cookie piece, a dough, a flake, a nugget and a snack food.

8. The extruded product of claim 1, wherein a serving size of the extruded product comprises at least 400 milligrams of the isolated or purified sterols.

9. The extruded product of claim 1, wherein the isolated or purified sterols are free sterols.

10. A process for producing a food product, comprising:
combining an isolated or purified sterol and a compound selected from the group consisting of a corn product, a legume product, a rice product, a flour product and any combination thereof, thus producing a first mixture;
combining water with the first mixture, thus producing a second mixture; and
subjecting the second mixture to heat, pressure or a combination thereof, thus producing a food product.

11. The process of claim 10, wherein subjecting the second mixture to heat, pressure or the combination thereof comprises extruding the second mixture.

12. The process of claim 10, further comprising drying the food product.

13. The process of claim 10, further comprising frying the food product in oil.

14. The process of claim 10, wherein the isolated or purified sterol has at least 95% free sterols.

15. A food stuff comprising;
at least one crisp consisting essentially of a sterol and compound selected from the group consisting of a corn product, a legume product, a rice product, a flour product and any combination thereof.

16. The food stuff of claim 15, comprising a plurality of the crisps.

17. The food stuff of claim 15, further comprising a binder adhering at least a portion of the plurality of crisps together.

18. The food stuff of claim 17, wherein the binder is selected from the group consisting of a syrup, a protein based binder and a combination thereof.

19. The food stuff of claim 15, further comprising a coating that covers at least a portion of the food stuff.

20. The food stuff of claim 15, further comprising an additive selected from the group consisting of an enrichment; a flour; calcium citrate; an oil; a maltodextrin; isoflavones; a vitamin; an artificial sweeter; soy grits; dry sweeteners; an emulsifier; and any combinations thereof.

21. The food stuff of claim 15, wherein the food stuff is an animal feed.
